(19) United States
(12) Patent Application Publication
(10) Pub. No.: US 2024/0347698 A1
(43) Pub. Date: Oct. 17, 2024

(54) Porous Carbon Structure-Hosted Silicon Oxide (SiOx), Anode, Lithium-ion Battery, and Production Method

(71) Applicant: Honeycomb Battery Company, Dayton, OH (US)

(72) Inventor: Bor Z. Jang, Centerville, OH (US)

(73) Assignee: Honeycomb Battery Company, Dayton, OH (US)

(21) Appl. No.: 18/300,430

(22) Filed: Apr. 14, 2023

(51) Int. Cl. H01M 4/36; H01M 4/04; H01M 4/48; H01M 4/583; H01M 4/62; H01M 10/0525

(52) U.S. Cl. CPC H01M 4/364; H01M 4/0471; H01M 4/48; H01M 4/583; H01M 4/624; H01M 10/0525; H01M 2004/021; H01M 2004/027

(57) ABSTRACT

A porous carbon/silicon oxide composite comprising: (A) a porous carbon structure host having pores; (B) a silicon oxide SiOₓ residing in a pore, where 0<x<2; and (C) a metal or non-metal element M dispersed in the SiOₓ or coated on a surface of the SiOₓ, wherein M is selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, As, or a combination thereof, and M occupies preferably from 0% to 30% by weight of the SiOₓ. Also provided is an anode, comprising such a porous carbon/silicon oxide composite, a lithium-ion cell comprising such an anode, and a method of producing the porous carbon/silicon oxide composite.

### FIELD

This invention relates generally to a silicon oxide composition (SiOₓ, 0<x<2) deposited in the pores of a porous carbon structure host, a method of producing such a porous carbon-hosted SiOₓ composition, an anode comprising such a composition, and a lithium-ion battery featuring such an anode.

### BACKGROUND

Lithium ion battery is a prime candidate energy storage device for electric vehicle (EV), renewable energy storage, and smart grid applications. Graphite materials have been widely used as an anode (negative electrode) active material for commercial lithium ion batteries due to their relatively low cost and excellent reversibility. However, the theoretical lithium storage capacity of graphite is only 372 mAh/g (based on LiC₆), which can limit the total capacity and energy density of a battery cell. The emerging EV and renewable energy industries demand the availability of rechargeable batteries with a significantly higher energy density and power density than what the current Li ion battery technology can provide. Hence, this requirement has triggered considerable research efforts on the development of electrode materials with higher specific capacity, excellent rate capability, and good cycle stability for lithium ion batteries.

Several elements from Group III, IV, and V in the periodic table can form alloys with Li at certain desired voltages. Therefore, various anode materials based on such elements and some metal oxides (e.g., SnO₂) have been proposed for lithium ion batteries. Among these, silicon is considered the most promising one since it has the highest theoretical specific capacity (up to 4,200 mAh/g in the stoichiometric form of Li_{4.4}Si) and low discharge potential (i.e., high operation potential when paired with a cathode). However, the dramatic volume change (up to 380%) of Si during lithium ion alloying and de-alloying (cell charge and discharge) often leads to severe and rapid battery performance deterioration. The performance fade (hence, a short cycle life) is mainly due to the volume change-induced pulverization of Si and the inability of the binder/conductive additive to maintain the electrical contact between the pulverized Si particles and the current collector.

Silicon oxide (SiOₓ, 0<x<2) has been considered as a good alternative anode material to silicon (Si) owing to its significantly better cycling stability. The SiOₓ powder is commonly obtained by heating a mixture of silicon dioxide (SiO₂) particles and silicon particles to generate SiOₓ gas, and the cooling the generated SiOₓ gas to obtain a solid deposit on a substrate, followed by finely pulverizing the deposit.

However, there are several major issues associated with the SiOₓ materials and the prior art processes for producing these materials:
1) Due to poor electrical conductivity. SiOₓ particles are often coated with a thin layer of carbon to improve their electrical conductivity. Unfortunately, SiOₓ particles also undergo severe volume expansion (up to 200%) when the battery cell is charged and such a volume expansion breaks the carbon coating into pieces, leading to rapid battery capacity decay.
2) The prior art processes are not capable of producing SiOₓ particles of consistent quality. These processes typically entail producing silicon dioxide (SiO₂) particles and silicon (Si) particles on a separate basis and then mixing these two types of solid particles together. Solid-to-solid mixing can led to inhomogeneous mixtures, resulting in SiOₓ particles that are inconsistent in quality. This is a highly undesirable feature for lithium-ion battery anode application.
3) Another major issue associated with the SiOₓ particles produced by the prior art methods is a low first-cycle coulombic efficiency (typically lower than 80%, more typically lower than 75%, and most typically from 68% to 72%). This implies that one can lose 20-32% of the lithium storage capacity after the first charge/discharge cycle.
4) Yet another major issue associated with the SiOₓ particles produced by the prior art methods is the electrode expansion caused by the large volume expansion (up to 200%) of SiOₓ particles. Although lower than the volume expansion of pure Si (300%-380%), a volume expansion of up to 200% can still lead to an excessive expansion of the negative electrode (anode) and the entire battery cell. This is a highly undesirable outcome for a battery to be used in an EV or consumer electronic device.

There is a clear need to have a better method of producing SiOₓ particles that impart better efficiency, longer cycle life, and smaller volume expansion to an anode or battery cell.

### SUMMARY

The aforementioned issues can be resolved by the presently disclosed porous carbon/silicon oxide composite and its production method.

In certain embodiments, the disclosed composite composition comprises: (a) a porous carbon structure host having pores; (b) a silicon oxide SiOₓ coating or particle residing in at least one of the pores, where 0<x<2, and wherein the weight fraction of SiOₓ in the composite is from 0.1% to 99%; and (c) an optional metal or non-metal element M dispersed in said SiOₓ or coated on a surface of the SiOₓ particle or coating, wherein M is selected from Al, Fe, Zn, Sn, Cu, Mn, Ni, Ti, V, Cr, Co, Zr, Nb, Mo, Ag, Au, Cd, Li, Na, K, Be, Mg. Ca, B, C, Ge, Ga, In, Sb, Bi, N, P, Pb, Se, S, As, or a combination thereof, and M is present as individual M atoms embedded in the SiOₓ particle or coating, as a domain or phase comprising multiple M atoms that are dispersed in the SiOₓ, or as a compound selected from an oxide, boride, carbide, nitride, silicide, halogenide, phosphide, or selenide of M, or a combination thereof, and wherein M occupies from 0% to 30% by weight of the SiOₓ particle or coating.

In certain preferred embodiments, M occupies from 0.01% to 20% by weight of the SiOₓ particle or coating and/or the weight fraction of SiOₓ in the composite is from 1% to 90%. The pores may preferably have a pore size from 5 nm to 5 μm and the porous carbon structure host has a porosity level from 0.5% to 99% prior to hosting the silicon oxide. Preferably, the porous carbon structure host has a porosity level from 20% to 80%. A highly desirable feature of the porous carbon host is that the pores are interconnected to facilitate entry and infiltration of SiOₓ vapor.

Preferably, the porous carbon/silicon oxide composite is in a particulate form having a particle size from 50 nm to 50 μm.

The porous carbon structure host may comprise a material selected from carbon foam, graphite foam, graphene foam, carbon aerogel, graphite aerogel, graphene aerogel, activated carbon, porous soft carbon, porous hard carbon, porous graphite particle, porous graphene particle or graphene ball, porous meso-carbon micro-bead (MCMB), porous coke particle, a porous structure of pyrolyzed polymer or polymeric carbon, or a combination thereof. Soft carbon refers to a carbon material that can be graphitized at a temperature higher than 2,500° C. and hard carbon refers to a carbon material that cannot be graphitized at a temperature higher than 2,500° C.

In some embodiments, the porous carbon/silicon oxide composite comprises at least a discrete, oxygen-free Si domain or phase dispersed in a SiOₓ matrix wherein the Si domain has a dimension from 2 nm to 500 nm.

In some embodiments, the porous carbon/silicon oxide composite comprises particles and the composite particles are further encapsulated by or coated with a layer of carbon, graphene, an ion-conducting polymer having a lithium ion conductivity no less than 106 S/cm, an electron-conducting polymer having an electric conductivity no less than 106 S/cm, or a combination thereof.

The ion-conducting polymer is preferably selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

The electron-conducting polymer preferably comprises a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy)phenylene vinylene), poly(p-phenylene vinylene), poly(2,5-dialkoxy) paraphenylene vinylene, poly [(1,4-phenylene-1.2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1.4-phenylene), poly(9,9-dioctylfluorene), polyquinoline, a derivative thereof, a copolymer thereof, a sulfonated version thereof, or a combination thereof.

The disclosure also provides an anode (negative electrode) for a lithium battery, wherein the anode comprises the disclosed porous carbon/silicon oxide composite as an anode material, an optional binder, and an optional conductive additive. The disclosure further discloses a lithium battery, wherein the lithium battery comprises an anode containing the disclosed porous carbon/silicon oxide composite, a cathode, a separator between the anode and the cathode, and an electrolyte in ionic contact with the anode and the cathode. The separator can contain the electrolyte or can simply be the electrolyte if the electrolyte is a solid-state electrolyte (polymeric, inorganic, or composite solid electrolyte).

The present disclosure also provides a method of producing the presently disclosed porous carbon/silicon oxide composite, the method comprising: (A) Preparing a reactant mixture of silicon dioxide (SiO₂) and silicon (Si) particles and preparing a porous carbon structure host having pores; (B) heating the reactant mixture to a reaction temperature (e.g., from 1,100° C. to 1,500° C.) under a vacuum or protective inert atmosphere for a length of reaction time to form silicon oxide, SiOₓ, and subliming or vaporizing the silicon oxide to a vapor state; and (C) directing the silicon oxide vapor to infiltrate at least a pore of the porous carbon structure host, which is maintained at a deposition temperature lower than the reaction temperature, facilitating the silicon oxide vapor to deposit as a solid in the pore to form the porous carbon/silicon oxide composite.

If the porous carbon host is a bulk structure, the method may further comprise a procedure of mechanically breaking down the porous carbon/silicon oxide composite, after step (C), into multiple composite particles of porous carbon/silicon oxide. The mechanical means for breaking down the porous carbon structure/silicon oxide composite may be selected from grinding, mechanical milling, air jet milling, or ball-milling.

In certain embodiments, the porous carbon host structure is in the form of individual porous carbon particles and the vapor infiltration procedure may be conducted in a fluidized bed environment to directly produce porous carbon/silicon oxide composite particles.

The method may further comprise a step of prelithiating the multiple composite particles of porous carbon/silicon oxide to form composite particles of porous carbon/prelithiated silicon oxide. Prelithiation may be conducted using a chemical method, electrochemical method, physical method, or a combination thereof.

The method may further comprise a step of encapsulating or coating the multiple composite particles of porous carbon/silicon oxide (with or without prelithiation) with a layer of carbon, graphene, an ion-conducting polymer having a lithium ion conductivity no less than 10⁻⁶ S/cm, an electron-conducting polymer having an electric conductivity no less than 10⁻⁶ S/cm, or a combination thereof. The graphene material involved in this method may be selected from pristine graphene, graphene oxide (GO), reduced graphene oxide (RGO), graphene fluoride (GF), graphene bromide (GB), graphene iodide (GI), boron-doped graphene, nitrogen-doped graphene, chemically functionalized graphene, or a combination thereof. The graphene material may include a single-layer or few-layer sheet of pristine graphene, graphene oxide, reduced graphene oxide, graphene fluoride, graphene chloride, graphene bromide, graphene iodide, boron-doped graphene, nitrogen-doped graphene, chemically functionalized graphene, or a combination thereof, wherein few layer is defined as less than 10 layers that are stacked together through van der Waals forces with a typical inter-graphene spacing of approximately 0.335 nm or slightly larger.

In the disclosed method, the starting materials may preferably contain (i) a plurality of silicon alloy particles (M_{y}Si), wherein M is a metal or non-metal element present on a surface of a silicon particle or in the interior of a silicon particle (e.g., Li- or B-doped Si particles) or (ii) a mixture of multiple Si particles and multiple M-containing particles (e.g., LiOH or boron oxide), or a mixture of (i) and (ii); wherein M is selected from Al, Fe, Zn, Sn, Cu, Mn, Ni, Ti, V, Cr, Co, Zr, Nb, Mo, Ag, Au, Cd, Li, Na, K, Bc, Mg, Ca, B, C, Ge, Ga, In, Sb, Bi, N, P, Pb, Se, S, As, or a combination thereof, and y is selected from 0 to 4.4 (preferably greater than 0.001, further preferably greater than 0.01, and most preferably greater than 0.1). In this situation, the process does not begin with mixing a starting Si alloy (or Si) and SiO₂ particles and the M-containing particles do not include SiO₂. In contrast, the prior art process for producing SiOₓ typically involves mixing Si particles with SiO₂ particles first, and then heating the resulting mixture to activate chemical reactions between Si and SiO₂ to form SiOₓ. However, it can be challenging to mix different solid particles together in a homogeneous or uniform manner. Without good mixing, the reactions between Si and SiO₂ particles cannot occur uniformly and the reactions often cannot be completed.

Preferably, in the silicon alloy particles M_{y}Si, y is selected from 0.01 to 1.0 and more preferably from 0.1 to 0.3. The silicon alloy particles preferably have a diameter from 20 nm to 50 μm, further preferably from 50 nm to 10 μm, still more preferably from 80 nm to 20 μm, and most preferably from 100 nm to 1 μm. In certain embodiments, element M, prior to step (B), exists as a single-element metal domain or as a compound of M on a surface or inside the internal structure of a silicon alloy particle.

In certain embodiments, the element M, upon conclusion of step (C), exists as a single-element metal domain (a small volume substantially consisting of just M atoms) or as a compound of M inside the internal structure of a silicon oxide particle, or as a compound of M on an external surface of the silicon oxide particle. The element M may be introduced to the interior or surface of a silicon alloy particle by using doping, ion implementation, physical vapor deposition, sputtering, atomic layer deposition, chemical vapor deposition, solution deposition, coating, spraying, painting, or a combination thereof. In some embodiments, the element M, upon conclusion of step (C), exists as a compound selected from oxide, boride, carbide, nitride, silicide, halogenide, phosphide, or selenide of M, or a combination thereof.

In certain embodiments, the reactant mixture of silicon dioxide (SiO₂) and silicon (Si) particles in step (A) is prepared by providing multiple Si particles and heating the multiple Si particles to an oxidation temperature for a period of oxidation time to form a plurality of core-shell particles, wherein a core-shell particle comprises a layer of silicon dioxide, SiO₂, which at least partially covers or encapsulate an underlying silicon core. The molar ratio of silicon-to-SiO₂ in a composite particle may be from 1/100 to 100/1. The oxidation temperature is from 500° C. to 1,000° C.

The oxidation of Si particles may be conducted in a first chamber and reactions of Si and SiO₂ is conducted in a first chamber or a second chamber of a reaction apparatus.

In some preferred embodiments, the porous carbon structure host comprises porous particles and step (C) is conducted in a fluidized bed environment to produce porous carbon/silicon oxide composite particles.

In certain embodiments, the reactant mixture further comprises a metal or non-metal element M, an M-containing alloy, or an M-containing compound that is mixed with the silicon dioxide (SiO₂) and silicon (Si) particles, wherein M is selected from Al, Fe, Zn, Sn, Cu, Mn, Ni, Ti, V, Cr, Co, Zr, Nb, Mo, Ag, Au, Cd, Li, Na, K, Bc, Mg, Ca, B, C, Ge, Ga, In, Sb, Bi, N, P, Pb, Sc, S, As, or a combination thereof; and wherein the silicon oxide vapor in step (B) comprises M and the deposited silicon oxide contains M that is doped or dispersed therein.

In the disclosed method, either (i) the silicon particles in step (A) comprise a plurality of silicon alloy particles, M_{y}Si, wherein M is a metal or non-metal element present on a surface of a silicon particle or in the interior of a silicon particle or (ii) the reactant mixture further comprises multiple M-containing particles; wherein M is selected from Al, Fc, Zn, Sn, Cu, Mn, Ni, Ti, V, Cr, Co, Zr, Nb, Mo, Ag, Au, Cd, Li, Na, K, Bc, Mg, Ca, B, C, Gc, Ga, In, Sb, Bi, N, P, Pb, Sc, S. As, or a combination thereof, and y is selected from 0.001 to 4.4 (typically from 0.1 to 1.0). In this situation, step (A) comprises heating (i) the silicon alloy particles or (ii) mixture of multiple Si particles and multiple M-containing particles to a first temperature for a first period of time to form (iii) a plurality of composite particles or (iv) a mixture of a plurality of composite particles and multiple M-containing particles, wherein a composite particle comprises a layer of silicon dioxide, SiO₂, at least partially covering or encapsulating an underlying silicon alloy or silicon core, and wherein said step (B) comprises heating (iii) the plurality of composite particles or (iv) the mixture to a second temperature under a vacuum or protective inert atmosphere for a second duration of time, sufficient for facilitating the silicon dioxide to react with the underlying silicon alloy or silicon core of a composite particle to form a substantially silicon oxide particle, SiOₓ, having M dispersed therein and vaporizing said silicon oxide to a vapor state.

In some embodiments, the method, during or after Step (B), further comprises a step of introducing a stream of a precursor gas containing an element M to mix and react with the silicon oxide vapor to form vapor of M-containing silicon oxide, wherein M is a metal or non-metal element selected from Al, Fe, Zn, Sn, Cu, Mn, Ni, Ti, V, Cr, Co, Zr, Nb, Mo, Ag, Au, Cd, Li, Na, K, Bc, Mg, Ca, B, C, Ge, Ga, In, Sb, Bi, N, P, Pb, Se, S, As, or a combination thereof, and M is present on a surface of a silicon oxide particle or in the interior of a silicon oxide after step (C) and the atomic ratio of M-to-Si in the M-containing silicon oxide is selected from 0.001 to 4.4.

The element M may be introduced to the interior or surface of a silicon alloy particle by using doping, ion implementation, physical vapor deposition, sputtering, atomic layer deposition, chemical vapor deposition, solution deposition, coating, spraying, painting, or a combination thereof.

### BRIEF DESCRIPTION OF THE DRAWINGS

FIG. 1(A) The prior art process for producing SiOₓ powder from mixing two previously prepared Si and SiO₂ powders, which are then heated to facilitate reaction between Si and SiO₂ particles to form a bulk deposit of SiOₓ. This is followed by a pulverization procedure to break down the deposit into individual particles.

FIG. 1(B) In a preferred embodiment, a process for producing uniformly reacted SiOₓ begins by heating and surface-oxidizing M-containing Si particles (M_{y}Si) to produce SiO₂-coated M_{y}Si powders, which are then heated to facilitate reaction between SiO₂ and underlying Si to form desirably or fully reacted SiOₓ (containing a homogeneous microstructure). The resulting SiOₓ is sublimed to become SiOₓ vapor which infiltrates into pores of a porous carbon host.

FIG. 1(C) Schematic of a lithium-ion cell comprising an anode (featuring a porous carbon host structure having SiOₓ residing in pores), a separator, and a cathode.

FIG. 2: A process flow chart showing preferred routes to prepare silicon oxide residing in pores of a porous carbon host according to some preferred embodiments.

FIG. 3: Another process flow chart showing preferred routes to prepare silicon oxide residing in pores of a porous carbon host according to some preferred embodiments.

FIG. 4: Schematic of an apparatus that can be used to produce composites comprising porous carbon structure/SiOₓ containing M, according to some preferred embodiments of the present disclosure.

FIG. 5: X-ray diffraction curves of SiOₓ and Li-doped SiOₓ particles.

FIG. 6: Charge (lithiation)/discharge (delithiation) curves of an SiOₓ-based anode in a half cell test and those of an anode of SiOₓ containing a metal M (M=Li herein as an example).

### DETAILED DESCRIPTION

The present disclosure provides a porous carbon/silicon oxide composite, comprising: (a) a porous carbon structure host having pores; (b) a silicon oxide SiOₓ coating or particle residing in at least one of the pores, where 0<x<2, and wherein the weight fraction of SiOₓ in the composite is from 0.1% to 99%; and (c) an optional metal or non-metal element M dispersed in said SiOₓ or coated on a surface of the SiOₓ particle or coating, wherein M is selected from Al, Fc. Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S. As, or a combination thereof, and M is present as individual M atoms embedded in the SiOₓ particle or coating, as a domain or phase comprising multiple M atoms that are dispersed in the SiOₓ, or as a compound selected from an oxide, boride, carbide, nitride, silicide, halogenide, phosphide, or selenide of M, or a combination thereof, and wherein M occupies from 0% to 30% by weight of the SiOₓ particle or coating.

We have surprisingly observed that a small amount of M (e.g., from 0.01% to 10% by weight) can significantly increase the first-cycle efficiency of a SiOₓ-based anode from typically 73-76% to 80-92%; this strategy has effectively overcome the most significant deficiency of SiOₓ as an anode active material in a lithium-ion cell.

In certain embodiments, M occupies from 0.01% to 20% by weight of the SiOₓ particle or coating and/or the weight fraction of SiOₓ in the composite is from 1% to 90%. The pores may preferably have a pore size from 5 nm to 5 μm and the porous carbon structure host has a porosity level from 0.5% to 99% prior to hosting the silicon oxide. Preferably, the pores are interconnected and the porous carbon structure host has a porosity level from 50% to 90%. Preferably, the porosity level of the porous carbon host remains from 5% to 65% by volume after SiOₓ is introduced into pores of the carbon host. These pores can accommodate the volume expansion of SiOₓ during the battery charge without inducing excessive volume increase of the anode (negative electrode).

The porous carbon structure host may comprise a material selected from carbon foam, graphite foam, graphene foam, carbon aerogel, graphite aerogel, graphene aerogel, activated carbon, porous soft carbon, porous hard carbon, porous graphite particle, porous graphene particle or graphene ball, porous meso-carbon micro-bead (MCMB), porous coke particle, a porous structure of pyrolyzed polymer or polymeric carbon, or a combination thereof. Soft carbon refers to a carbon material that can be graphitized at a temperature higher than 2,500° C. and hard carbon refers to a carbon material that cannot be graphitized at a temperature higher than 2,500° C. The production of carbon foam, graphite foam, graphene foam, carbon aerogel, graphite aerogel, graphene aerogel, activated carbon, porous soft carbon, porous hard carbon, porous graphite particle, porous graphene particle or graphene ball, porous meso-carbon micro-bead (MCMB), porous coke particle, a porous structure of pyrolyzed polymer or polymeric carbon is generally known in the art.

In some embodiments, the porous carbon/silicon oxide composite comprises at least a discrete, oxygen-free Si domain or phase dispersed in a SiOₓ matrix wherein the Si domain has a dimension from 2 nm to 500 nm.

In some embodiments, the porous carbon/silicon oxide composite comprises particles (not in bulk form), having a size from 50 nm to 50 μm, and the composite particles are further encapsulated by or coated with a layer of carbon, graphene, an ion-conducting polymer having a lithium ion conductivity no less than 10⁻⁶ S/cm, an electron-conducting polymer having an electric conductivity no less than 10⁻⁶ S/cm, or a combination thereof.

The ion-conducting polymer is preferably selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

The electron-conducting polymer preferably comprises a conjugated polymer selected from polyacetylene, polythiophene, poly(3-alkylthiophenes), polypyrrole, polyaniline, poly(isothianaphthene), poly(3,4-cthylenedioxythiophene), alkoxy-substituted poly(p-phenylene vinylene), poly(2,5-bis(cholestanoxy)phenylene vinylene), poly(p-phenylene vinylene), poly(2,5-dialkoxy) paraphenylene vinylene, poly [(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

The present disclosure also provides a method of producing the presently disclosed porous carbon/silicon oxide composite, the method comprising: (A) Preparing a reactant mixture of silicon dioxide (SiO₂) and silicon (Si) particles and preparing a porous carbon structure host having pores; (B) heating the reactant mixture to a reaction temperature (e.g., from 1,100° C. to 1,500° C.) under a vacuum or protective inert atmosphere for a length of reaction time to form silicon oxide, SiOₓ, and subliming or vaporizing the silicon oxide to a vapor state; and (C) directing the silicon oxide vapor to infiltrate at least a pore of the porous carbon structure host, which is maintained at a deposition temperature lower than the reaction temperature, facilitating the silicon oxide vapor to deposit as a solid in the pore to form the porous carbon/silicon oxide composite.

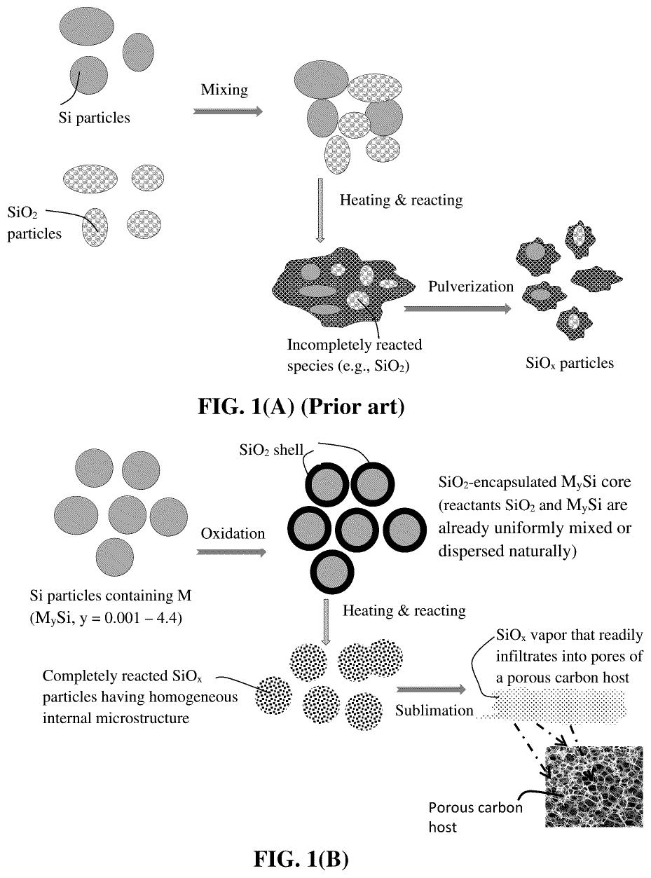

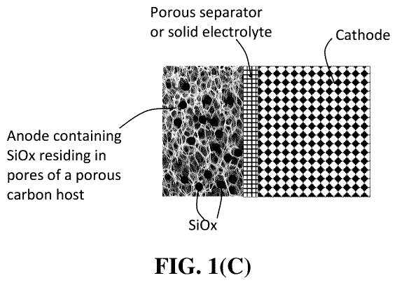

As mentioned earlier, the prior art SiOₓ powder is commonly produced by preparing Si powder and SiO₂ powder (the two primary reactants) separately, which are then physically blended together to form a mixture (illustrated in FIG. 1(A)). This is followed by heating the SiO₂/Si powder mixture to a high temperature (typically 1,250° C. to 1,450° C.), allowing the following reaction to occur: m SiO₂+n Si=(m+n) SiOₓ. The heat also sublimes the reaction product SiOₓ into a gaseous (vapor) state. Typically, the SiOₓ vapor is then cooled and directed to deposit on a solid substrate to obtain a solid deposit thereon. The solid deposit is then scratched off from the substrate and pulverized to become fine SiOₓ particles, typically 1-50 μm in size. This prior art process is then completed by coating the SiOₓ particles with a layer of carbon to improve the electron conductivity. There is a problem associated with the resulting carbon-coated SiOₓ particles. A SiOₓ particle can experience a volume expansion of up to 200% during battery charging (lithiation), resulting in the breakage of the carbon coating originally deposited thereon. This issue can be solved by the presently disclosed method of providing a porous carbon structure and infiltrating the SiOₓ vapor into the pores of this carbon host.

Further, the process of first producing silicon dioxide (Si (2) particles and silicon particles on a separate basis and then mixing these two types of solid particles together can led to inhomogeneous mixtures, resulting in SiOₓ particles that are inconsistent in quality. This is a highly undesirable feature for lithium-ion battery anode applications. Uniform mixing of two or three types of solid particles is known to be a challenging task.

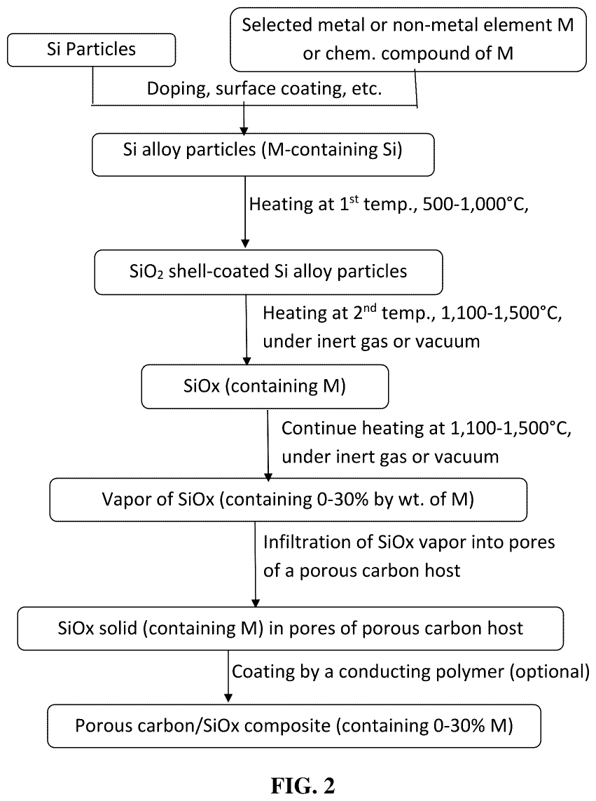

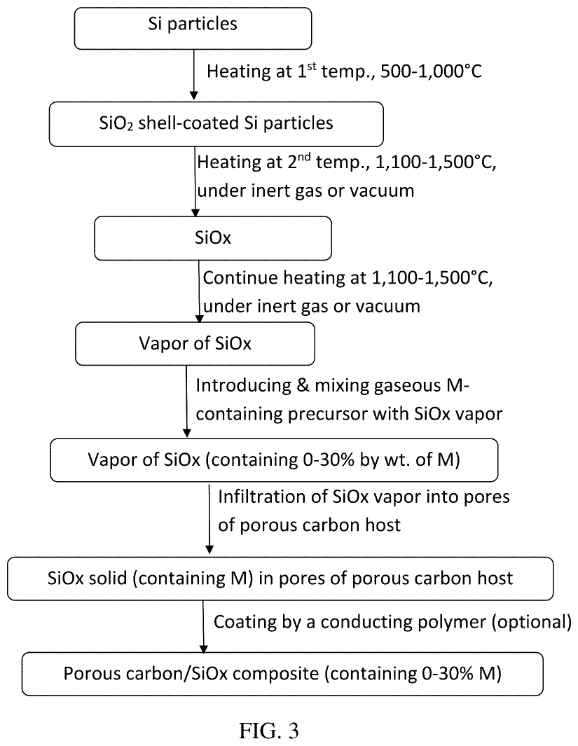

After extensive experimental work and in-depth analysis, we have come to realize that uniform mixing of SiOₓ and Si may be conveniently and effectively achieved by preparing Si particles as the primary starting material and then exposing Si particles to an oxidizing environment (e.g., room air at a temperature of 400-1,000° C.) to form a shell of SiO₂ that partially or fully encapsulates a core of Si. In other words, a surface layer of a Si particle gets oxidized to become SiO₂ and the core portion of the particle remains as Si. By controlling the amount of the encapsulating SiO₂ shell relative to the residual Si core amount, one can obtain particles that already contains both reactants (Si and SiO₂ co-existing in the same particle) that are in a desired molecular ratio and in intimate contact. A powder mass comprising multiple Si/SiO₂ core/shell structured particles is automatically or naturally a uniform “mixture” of the two reactants. This process is further schematically illustrated in FIG. 2.

As illustrated in FIG. 1(B) as a preferred embodiment, the present disclosure provides a process for cost-effectively producing uniformly reacted SiOₓ that is deposited in pores of a carbon host. This process begins by heating and surface-oxidizing M-containing Si particles (M_{y}Si, y from 0 to 4.4) to produce SiO₂-coated M_{y}Si powders, which are then heated to facilitate reaction between SiO₂ and underlying Si to form desirably or fully reacted M-containing SiOₓ having a homogeneous microstructure. The M-containing SiOₓ is then sublimed to a vapor state, with the vapor introduced into the pores of a porous carbon structure host. Herein, M is a metal or non-metal element selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, As, or a combination thereof.

In some embodiments, one may introduce a desired amount of an element M or a chemical compound (e.g., oxide, nitride, boride, etc.) of M into the internal structure of a starting Si particle (e.g., via ion implementation) or onto the surface of a Si particle (e.g., via sputtering or vapor deposition), but preferably not to fully cover the entire Si particle surface. The Si particles are preferably spherical or ellipsoidal in shape, but there is no limitation on the particle shape. Preferably, the Si particle has a size (diameter) from 20 nm to 50 μm, more preferably from 50 nm to 10 μm, and most preferably from 100 nm to 1 μm. The incorporation of an elemental M or M-containing compound can be controlled to provide enhanced properties of the resulting SiOₓ-containing composite particles, an anode electrode, and a battery that contains such particles. This will be further discussed later.

If the porous carbon host is a bulk structure, the method may further comprise a procedure of mechanically breaking down the porous carbon/silicon oxide composite structure, after step (C), into multiple composite particles of porous carbon/silicon oxide. The mechanical means for breaking down the porous carbon structure/silicon oxide composite may be selected from grinding, mechanical milling, air jet milling, or ball-milling.

In certain embodiments, the porous carbon host structure is in the form of individual porous carbon particles and the vapor infiltration procedure may be conducted in a fluidized bed environment to directly produce porous carbon/silicon oxide composite particles.

As illustrated in FIG. 1(C), the present disclosure also provides an anode featuring a porous carbon host structure having SiOₓ residing in pores (left side of FIG. 1(C)) and a lithium-ion cell comprising such an anode, a separator, and a cathode.

In summary, the present disclosure provides a method of producing multiple composite particles of silicon oxide SiOₓ, where 0<x<2. The method, as illustrated in FIG. 2, comprises: (a) preparing (i) a plurality of silicon alloy particles, M_{y}Si, wherein M is a metal or non-metal element present on a surface of a silicon particle or in the interior of a silicon particle or preparing (ii) a mixture of multiple Si particles and multiple M-containing particles; wherein M is selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, As, or a combination thereof, and y is selected from 0.001 to 4.4; (b) heating said (i) silicon alloy particles or (ii) mixture of multiple Si particles and multiple M-containing particles to a first temperature for a first period of time to form (iii) a plurality of composite particles or (iv) a mixture of a plurality of composite particles and multiple M-containing particles, wherein a composite particle comprises a layer of silicon dioxide, SiO₂, at least partially covering or encapsulating an underlying silicon alloy or silicon core; (c) heating (iii) the plurality of composite particles or (iv) the mixture to a second temperature under a vacuum or protective inert atmosphere for a second duration of time, allowing the silicon dioxide to react with the underlying silicon alloy or silicon core of a composite particle to form a substantially silicon oxide particle, SiOₓ, having M dispersed therein and vaporizing said silicon oxide to a vapor state; and (d) directing the silicon oxide vapor to infiltrate the pores of a porous carbon structure host to form a composite structure comprising solid silicon oxide residing in pores of the carbon host. If the porous carbon host is a bulk structure, one may then use mechanical means to break down the bulk structure, obtaining multiple composite particles of porous carbon/silicon oxide.

Preferably, the first temperature is from 500° C. to 1,000° C. and the second temperature is from 1,100° C. to 1,500° C. In step (b), a preferred molar ratio of silicon-to-SiO₂ in a composite particle is from 1/100 to 100/1.

Preferably, in the silicon alloy particles M_{y}Si, y is selected from 0.01 to 1.0 and more preferably from 0.1 to 0.3. In certain embodiments, element M, prior to step (b), exists as a single-element metal domain or as a compound of M on a surface or inside the internal structure of a silicon alloy particle. Alloying of Si with other metal elements such as Al, Li, Cu, Zn, Na is well-known in the art. For instance, in the semiconductor industry, Si may be doped with an n-type or p-type dopant to obtain certain improved electronic property (e.g., conductivity). Ion implementation is commonly used to introduce dopants like B into Si. Alternatively, one may simply deposit a layer of M or an M-containing compound to cover portion of the external surface of a Si particle via physical vapor deposition, chemical vapor deposition, sputtering, solution phase deposition, etc.

As such, in certain embodiments of the present disclosure, the element M, upon conclusion of step (d), exists as a single-element metal domain (a small volume substantially consisting of just M atoms) or as a compound of M inside the internal structure of a silicon oxide particle, or as a compound of M on an external surface of the silicon oxide particle. The element M may be introduced to the interior or surface of a silicon alloy particle by using doping, ion implementation, physical vapor deposition, sputtering, atomic layer deposition, chemical vapor deposition, solution deposition, coating, spraying, painting, or a combination thereof. In some embodiments, the element M, upon conclusion of step (d), exists as a compound selected from oxide, boride, carbide, nitride, silicide, halogenide, phosphide, or selenide of M, or a combination thereof.

The incorporation of an element M or M-containing compound during the SiOₓ production process led to some unexpected and highly beneficial outcomes. One surprising result is the notion that an anode (negative electrode) that contains composite particles of porous carbon/SiOₓ produced in this manner typically exhibits a significantly lower degree of electrode volume variations (expansion/shrinkage) during battery charging/discharging. This is conducive to a much more stable battery cycling behavior and longer cycle life. Another surprising result is that both the composite porous carbon/SiOₓ structure and the anode electrode are capable of maintaining structural integrity during battery cycling, substantially avoiding structural failure; e.g., particle pulverization, thus exposing new surfaces to liquid electrolyte that would otherwise consume more electrolyte by forming new solid-electrolyte interphase. These side effects can cause a rapid capacity decay.

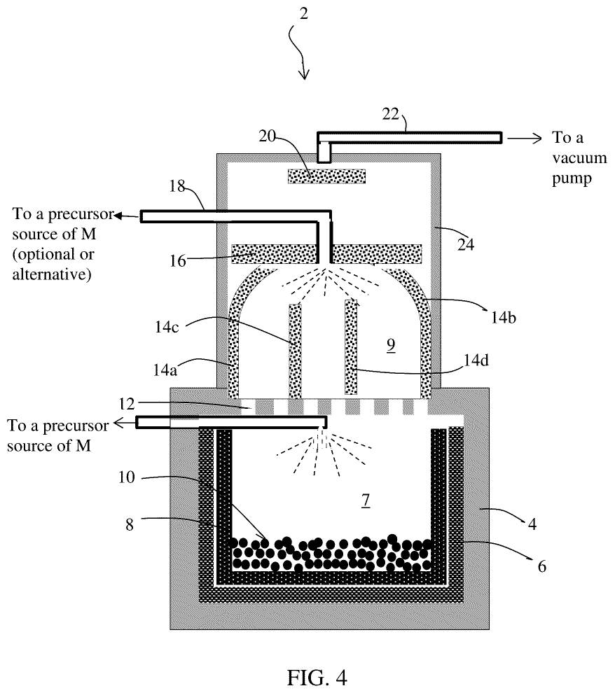

FIG. 4 schematically shows an apparatus 2 that can be used to produce M-containing SiOₓ deposited in pores of a carbon host, according to some preferred embodiments of the present disclosure. This apparatus has a supporting body 4 that hosts a crucible 8 to accommodate the starting reactant materials (e.g., Si particles 10 in a first chamber 7). This crucible may be heated by a heating provision (e.g., heating elements 6) that brings the temperature of the reactants to a first temperature (e.g., in the range of 500° C. to 1,000° C.) for a first period of time (e.g., 0.5-12 hours) to allow for formation of SiO₂ on Si particle surfaces. The chamber is then heated to a second but higher temperature (e.g., in the range of 1,100° C. to 1,500° C.) for a second period of time (e.g., 0.5 to 24 hours). This higher temperature enables the desired chemical reaction between a Si core and a SiO₂ shell of the same reactant particle under a vacuum or inert gas condition. In one preferred embodiment, a vacuum pump (not shown) is operated to help move the SiOₓ vapor through channels 12 into the second chamber 9, which is disposed in the upper portion (defined by 24) of the apparatus. Multiple porous carbon structure hosts 14a, 14b, 14c, 14d, 16, 20 may be disposed in this second chamber 9 to accommodate the infiltrating SiOₓ vapor that deposits as a SiOₓ solid particle or coating inside pores of a host.

It may be noted that the apparatus does not have to have two chambers (e.g., 7 and 9). One may choose to use just one chamber if the starting reactants contain a mixture of Si or M_{y}Si particles and SiO₂ particles (with or without M), instead of just Si or M_{y}Si particles (with or without M).

The method may further comprise a step of coating or encapsulating one or a plurality of composite particles of porous carbon host/silicon oxide with a thin layer of graphene having a thickness from 0.34 nm to 100 nm. This can be accomplished by dispersing SiOₓ-containing composite particles and graphene sheets in a liquid medium to form a slurry, which is then spray-dried to form secondary particles containing SiOₓ particles encapsulated by graphene sheets. The graphene material involved in this method may be selected from pristine graphene, graphene oxide (GO), reduced graphene oxide (RGO), graphene fluoride (GF), graphene bromide (GB), graphene iodide (GI), boron-doped graphene, nitrogen-doped graphene, chemically functionalized graphene, or a combination thereof. The graphene material may include a single-layer or few-layer sheet of pristine graphene, graphene oxide, reduced graphene oxide, graphene fluoride, graphene chloride, graphene bromide, graphene iodide, boron-doped graphene, nitrogen-doped graphene, chemically functionalized graphene, or a combination thereof, wherein few layer is defined as less than 10 layers that are stacked together through van der Waals forces with a typical inter-graphene spacing of approximately 0.335 nm or slightly larger.

In certain embodiments, the method may further comprise a step of coating or encapsulating one or a plurality of composite particles of porous carbon host/silicon oxide (with or without element M) with a thin layer of ion-conducting and/or electron-conducting polymer. The method of encapsulating solid particles by a polymer is well known in the art; e.g., via spray drying, pan-coating method, air-suspension coating method, centrifugal extrusion, vibrational nozzle method, coacervation-phase separation, interfacial polycondensation and interfacial cross-linking, In-situ polymerization, and matrix polymerization.

In certain embodiments, the introduction of the metal or non-metal element M is conducted after (rather than before) the SiOₓ is formed. As such, the present disclosure further provides a method of producing multiple particles of silicon oxide SiOₓ, where 0<x<2, the method comprising: (a) preparing a plurality of silicon particles; (b) heating said silicon particles to a first temperature for a first period of time to form a plurality of composite particles, wherein a composite particle comprises a layer of silicon dioxide, SiO₂, at least partially covering or encapsulating an underlying silicon; (c) heating the plurality of composite particles to a second temperature under a vacuum or protective inert atmosphere for a second duration of time, allowing the silicon dioxide to react with the underlying silicon of a composite particle to form a silicon oxide particle and vaporizing said silicon oxide to a vapor state; (d) introducing a stream of a precursor gas containing an element M to mix and react with the silicon oxide vapor to form vapor of M-containing silicon oxide, wherein M is a metal or non-metal element selected from Al. Fc. Zn, Sn, Cu, Mn, Ni, Ti, V, Cr, Co, Zr, Nb, Mo, Ag, Au, Cd, Li, Na, K, Bc, Mg, Ca, B, C, Ge, Ga, In, Sb, Bi, N, P, Pb, Se, S, As, or a combination thereof, and M is present on a surface of a silicon oxide particle or in the interior of a silicon oxide and the atomic ratio of M-to-Si in the M-containing silicon oxide is selected from 0.001 to 4.4; and (e) directing the M-containing silicon oxide vapor into pores of a porous carbon host to form a composite structure comprising M-containing solid silicon oxide therein.

In some preferred embodiments, the anode active material residing in the pores of a carbon host (the composite) comprises discrete, oxygen-free Si domains or phase dispersed in a SiOₓ matrix wherein the Si domains have a dimension from 2 nm to 200 nm. In some specific embodiments, the composite particle is a core/shell structure comprising a core of discrete, oxygen-free Si domain or phase encapsulated by a shell of SiOₓ matrix, wherein the Si domain core has a dimension from 10 nm to 200 nm.

### Example 1: Preparation of Graphitic Foam (as a Porous Carbon Structure Host) from Pitch-Based Carbon Foams

Pitch powder, granules, or pellets are placed in an aluminum mold with the desired final shape of the foam. Meso-phase pitch was evacuated to less than 1 torr and then heated to a temperature approximately 300° C. At this point, the vacuum was released to a nitrogen blanket and then a pressure of up to 1,000 psi was applied. The temperature of the system was then raised to 800° C. This was performed at a rate of 2 degree C./min. The temperature was held for at least 15 minutes to achieve a soak and then the furnace power was turned off and cooled to room temperature at a rate of approximately 1.5 degree C./min with release of pressure at a rate of approximately 2 psi/min. Final foam temperatures were 630° C. and 800° C. During the cooling cycle, pressure is released gradually to atmospheric conditions. The foam was then heat treated to 1050° C. (carbonized) under a nitrogen blanket and then heat treated in separate runs in a graphite crucible to 2500° C. and 2800° C. (graphitized) in Argon.

### Examples 2a and 2b: Preparation of Carbon Foams (CFs), as a Porous Carbon Structure Host, from Waste Polyurethane (PU) Elastomer and Polyimide-Coated PU

The CFs were prepared using the waste PU elastomer template following two different activation approaches. A brief description is given below:

For foam pretreatment, a PU elastomer sample was cut into cubes and immersed in acidified sucrose solution (2.5 g/mL) for 12 h followed by room drying overnight and cured in a hot air oven at 110° C. for 10 h. The treated foams were first pyrolyzed in N₂ at 900° C. (heating rate—10° C./min) for 60 min followed by activation in CO₂ (flowrate—200 mL/min) at 1,000° C. (heating rate—10° C./min) for 100 min.

Polyimide-derived carbon foams were prepared using polyurethane foams as a template. Impregnation of polyimide precursor, poly(amide acid), followed by imidization at 200° C. gave polyurethane/polyimide (PU/PI) composite foams, which resulted in PI foams by heating above 400° C. and then carbon foams above 800° C. Some foam samples carbonized at 1000° C. were further heat-treated at 3000° C. to obtain graphite foams.

### Example 3: Graphene Foams (as a Porous Carbon Structure Host) from Hydrothermally Reduced Graphene Oxide

A self-assembled graphene hydrogel (SGH) sample was prepared by a one-step hydrothermal method. In a typical procedure, the SGH was prepared by heating 2 mg/mL of homogeneous graphene oxide (GO) aqueous dispersion sealed in a Teflon-lined autoclave at 180° C. for 12 h. The SGH containing about 2.6% (by weight) graphene sheets and 97.4% water has an electrical conductivity of approximately 5×10⁻³ S/cm. Upon drying and heat treating at 1,500° C., the resulting graphene foam exhibits an electrical conductivity of approximately 1.5×10⁻¹ S/cm.

### Example 4: Plastic Bead Template-Assisted Formation of Reduced Graphene Oxide (GO) Foams (as a Porous Carbon Structure Host)

A hard template-directed ordered assembly for a macro-porous bubbled graphene film (MGF) was prepared. Mono-disperse poly methyl methacrylate (PMMA) latex spheres were used as the hard templates. The GO/water suspension (supplied from Angstron Materials, Inc., Dayton, Ohio) was mixed with a PMMA spheres suspension. Subsequent vacuum filtration was conducted to prepare the assembly of PMMA spheres and GO sheets, with GO sheets wrapped around the PMMA beads. A composite film was peeled off from the filter, air dried and calcinated at 800° C. to remove the PMMA template and thermally reduce GO into RGO (reduced graphene oxide) simultaneously. The grey free-standing PMMA/GO film turned black after calcination, while the graphene film remained porous.

### Example 5: Production of Graphene Balls (Porous Graphene Particles as a Porous Carbon Structure Host) from Flake Graphite Via Polypropylene Powder-Based Solid Polymer Carrier

In an experiment, 1 kg of polypropylene (PP) pellets, 50 grams of flake graphite, 50 mesh (average particle size 0.18 mm; Asbury Carbons, Asbury NJ) and 250 grams of magnetic steel balls were placed in a high-energy ball mill container. The ball mill was operated at 300 rpm for 2 hours. The container lid was removed and stainless steel balls were removed via a magnet. The polymer carrier material was found to be coated with a dark graphene layer. Carrier material was placed over a 50 mesh sieve and a small amount of unprocessed flake graphite was removed.

A sample of the coated carrier material was then submitted to air flow suspension in a heating chamber, wherein the graphene-coated PP particles were heat-treated at 350° C. and then at 600° C. for 2 hours to produce individual (isolated/separated) graphene balls.

In a separate experiment, the same batch of PP pellets and flake graphite particles (without the impacting steel balls) were placed in the same high-energy ball mill container and the ball mill was operated under the same conditions for the same period of time. The results were compared with those obtained from impacting ball-assisted operation. The graphene sheets isolated from PP particles, upon PP dissolution, are mostly single-layer graphene. The graphene balls produced from this process typically have a higher level of porosity (lower physical density).

### Example 6: Production of Graphene Balls from Natural Graphite Particles, Polyethylene (PE) or Nylon 6/6 Beads, and Ceramic or Glass Beads as Added Impacting Balls

In an experiment, 0.5 kg of PE or nylon beads (as a solid carrier material), 50 grams of natural graphite (source of graphene sheets) and 250 grams of zirconia powder (impacting balls) were placed in containers of a planetary ball mill. The ball mill was operated at 300 rpm for 4 hours. The container lid was removed and zirconia beads (different sizes and weights than graphene-coated PE beads) were removed through a vibratory screen. The polymer carrier material particles were found to be coated with a dark graphene layer. Carrier material was placed over a 50 mesh sieve and a small amount of unprocessed flake graphite was removed. In a separate experiment, glass beads were used as the impacting balls; other ball-milling operation conditions remained the same.

A mass of graphene-coated PE pellets and a mass of graphene-coated nylon beads were separately subjected to pyrolyzation (by heating the compacts in a chamber from 100° C. to 650° C.) while being suspended in a nitrogen gas stream for producing graphene balls. SEM examination of these structures indicates that carbon phases are present near the edges of graphene sheets and these carbon phases act to bond the graphene sheets together. The carbon-bonded graphene sheets form a shell of a graphene ball.

### Example 7: Preparation of Porous Activated Carbon-Hosted SiOₓ from Lithium-Doped Silicon Particles Alone (No SiO₂ Present in the Reactant)

Highly porous activated carbon structures (AC particles) are commonly available; they can be readily prepared by purifying and activating coconut shells, for instance. These porous AC particles were compacted into layers of porous structures to host infiltrating SiOₓ vapor species in a vacuum chamber.

In an experiment, a sample of 5 kg Li-doped silicon powder having particle sizes of 0.5-2.1 μm (supplied from Angstron Energy Co., Dayton, Ohio) was placed in a high-temperature furnace, FIG. 4. The apparatus was then heated to 800° C. and maintained at this temperature for 6 hours under a room air condition (exposing to oxygen in the air) to induce oxidation of Si on the surface of each Li-doped Si particle, forming a shell layer of SiO₂ encapsulating an underlying doped Si core. The furnace was then pumped to a vacuum pressure of 10 Pa and heated to 1350° C., maintaining at this temperature for 3 hours, enabling reactions between a SiO₂ shell and a Si core to produce SiOₓ. The temperature was also sufficient to sublime the reaction product (Li-containing SiOₓ) into a vapor state. In one experiment, the Li-containing SiOₓ vapor was flowed into the upper portion (second chamber) of the apparatus where the vapor was cooled and deposited onto a surface of a solid collector. The SiOₓ solid deposit was removed from the collector surfaces and pulverized into smaller particles. In another experiment, the Li-containing SiOₓ vapor was directed to permeate into pores of activated carbon particles.

A comparative example sample of SiOₓ (herein referred to as Comparative Example 1) was prepared in a similar manner with the exception that the starting material was Si without any pre-doping.

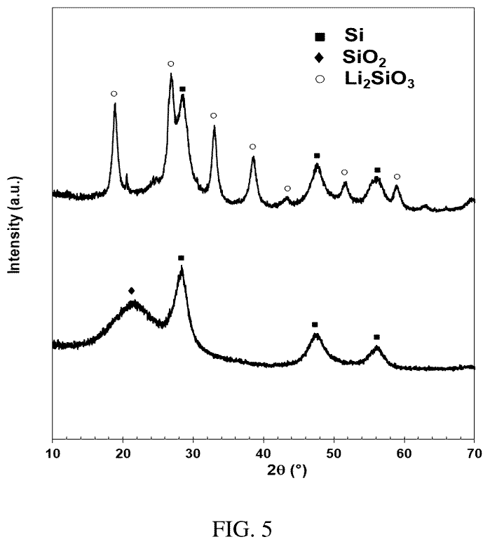

The X-ray diffraction curve of Example 1 and that of Comparative Example 1 are shown in FIG. 5, indicating the chemical compositions of Example 7 contain Si, SiO₂, and Li₂SiO₃. SEM and TEM studies indicate that the composite comprises discrete, oxygen-free Si domains dispersed in a SiOₓ matrix wherein the Si domains have a dimension from 2 nm to 155 nm. Very fine, nano-scaled Li₂SiO₃ domains were uniformly dispersed in both the Si and SiO₂ phase.

For electrochemical testing, the working electrodes were prepared by mixing 95 wt. % active material (porous activated carbon particles containing SiOₓ, inside their pores), and 5 wt. % polyvinylidene fluoride (PVDF) binder dissolved in N-methyl-2-pyrrolidinoe (NMP) to form a slurry of 5 wt. % total solid content. After coating the slurries on Cu foil, the electrodes were dried at 120° C. in vacuum for 2 h to remove the solvent before pressing. Then, the electrodes were cut into a disk (ϕ=12 mm) and dried at 100° C. for 24 h in vacuum. Electrochemical measurements were carried out using CR2032 (3V) coin-type cells with lithium metal as the counter/reference electrode, Celgard 2400 membrane as separator, and 1 M LiPF₆ electrolyte solution dissolved in a mixture of ethylene carbonate (EC) and diethyl carbonate (DEC) (EC-December 1:1 v/v). The cell assembly was performed in an argon-filled glove-box. The CV measurements were carried out using an electrochemical workstation at a scanning rate of 1 mV/s.

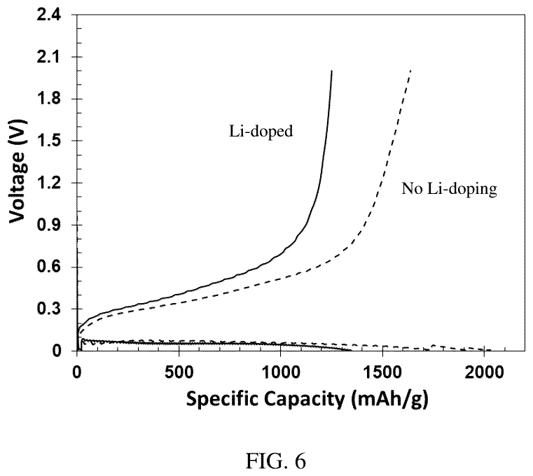

The prepared button half-cells were also tested in a constant current charge-discharge mode using a charge-discharge meter, with a discharge cut-off voltage of 0.005V, a charging cut-off voltage of 2V, and a charge and discharge test of 0.1C current density in the first week. The first-cycle Coulombic efficiency and specific capacity of all cells were measured. We have observed that the first cycle efficiency of the Li-containing SiOₓ anode prepared according to the presently disclosed method is typically in the range of 91-93%, in contrast to typically 78-82% of SiOₓ anodes prepared by using the presently disclosed process (but without doping by a third element M). Although without the presence of M, the anode can store more charges per unit anode mass, the excessively low first-cycle efficiency is known as a highly detrimental problem for SiOₓ-based anode material (FIG. 6).

Further, the first-cycle efficiency is typically in the range of 72-78% for SiOₓ anodes prepared by using prior art processes that begin with the preparation of Si and SiO₂ separately, followed by mixing and reaction.

Full-cell tests were also conducted. For the preparation of an anode, the SiOₓ-based composite material and graphite were mixed and configured in a composite with a specific capacity of 450 mAh/g. The anode active material mixture and the binder were weighed and mixed in a ratio of 95%: 5%. At room temperature, the mixed material and solvent (deionized water) were made into a slurry, which was evenly coated on the copper foil, and dried at a temperature between 70-100° C.

The preparation of the cathode piece was obtained according to the ratio of 96%: 2%: 2% weighed nickel-cobalt manganate lithium (NMC) ternary cathode material, conductive additive and binder. At room temperature, the three component materials were dispersed in NMP to form a slurry. The prepared slurry was evenly coated on the aluminum foil and dried at 90-120° C.

In the preparation of a full cell, the positive electrode (cathode) sheet had aluminum tabs as exposed tabs, the negative electrode (anode) sheet using copper plated Nickel tabs as exposed tabs. The prepared positive and negative electrode sheets and separators were wound into dry cells, and then the cells are encapsulated by the heat sealing process using aluminum plastic film, baked in a high temperature vacuum oven to remove the moisture in the battery, and then injected with 1 mole of electrolyte. The electrolyte, a mixed solution of LiPF₆ and vinyl carbonate/dimethyl carbonate (EC/DMC), was injected into a cell and vacuum sealed to obtain a battery cell.

The electrochemical behaviors of the full cells were characterized by using a charge-discharge meter for constant current charge-discharge mode test with a discharge cut-off voltage of 2.75V and charging cut-off voltage is 4.2V. The discharge test after the first week was carried out at a current density of 10C rate.

The electrode expansion rate test was conducted in the following manner: After the battery cells were fully charged/discharged for 300 cycles and 600 cycles, respectively, 5 cells each were dismounted from the testing station. The cell was open and the negative electrode piece was removed. The thickness of 10 different areas of each electrode was measured with a thickness gauge, and the average value was taken. Under the same test conditions, the average thickness of the electrode in the initial state was obtained as well.

The calculation formula used is: the full expansion rate of the electrode=(the average thickness of the electrode when a desired number of cycles was reached−the initial average of the electrode thickness)/initial average thickness of the electrode piece. The obtained data are listed in Table 1.

### Example 8: Preparation of SiOₓ (Residing in Carbon Foam Pores Prepared in Example 2) from Si, Lithium Hydride, and Boron Oxide Particles

The process was similar to that described in Example 7 with the exceptions that the starting materials and the porous carbon hosts were different. In an experiment, 5 kg silicon powder (not previously doped) having a diameter of 80-150 nm, 190 g boron oxide, and 130 g lithium hydride were mixed evenly and placed in a high-temperature furnace. The apparatus was then heated to 800° C. and maintained at this temperature for 6 hours under a room air condition (exposing to oxygen in the air) to induce oxidation of Si on the surface of each Si particle, forming a shell layer of SiO₂ encapsulating an underlying Si core. The furnace was then pumped to a vacuum pressure of 10 Pa and heated to 1350° C., maintaining at this temperature for 3 hours, enabling reactions between a SiO₂ shell and a Si core, along with boron oxide and lithium hydride, to produce B/Li-containing SiOₓ. The temperature was also sufficient to sublime the reaction product (B/Li-containing SiOₓ) into a vapor state. The B/Li-containing SiOₓ vapor was flowed into the upper portion (second chamber) of the apparatus where the vapor was introduced into pores of carbon foam structures. Similar electrochemical tests as those described in Example 1 were performed and the data are given in Table 1.

### Example 9: Preparation of SiOₓ (Deposited in Pores of Graphene Foam Prepared in Example 3) from Si and Magnesium Oxide Powder

The process was similar to that described in Example 8. In one example, 6.0 kg Si and 230 g magnesium oxide were mixed evenly and placed in a high temperature vacuum furnace. The apparatus was then heated to 600° C. and maintained at this temperature for 6 hours under a room air condition (exposing to oxygen in the air) to induce oxidation of Si on the surface of each Si particle, forming a shell layer of SiO₂ encapsulating an underlying Si core. The furnace was then pumped to a vacuum pressure of 50 Pa and heated to 1200° C., maintaining at this temperature for 3 hours, enabling reactions between a SiO₂ shell and a Si core, along with magnesium oxide, to produce Mg-containing SiOₓ. The temperature was also sufficient to sublime the reaction product (Mg-containing SiOₓ) into a vapor state. The Mg-containing SiOₓ vapor was flowed into the upper portion (second chamber) of the apparatus, where the vapor was introduced into pores of carbon foam. Similar electrochemical tests as those described in Example 1 were performed and the data are given in Table 1.

### Example 10: Preparation of SiOₓ (Hosted by Pores in Graphene Balls Prepared in Example 5) from Si, Sulfur(S), and Tin-Nickel Alloy

The process was similar to that described in Example 9, but the porous carbon host was graphene balls. In one example, 5.0 kg Si, 500 g sulfur powder, and 200 g tin-nickel alloy were mixed evenly and placed in a high temperature vacuum furnace. The apparatus was then heated to 600° C. and maintained at this temperature for 3 hours under a room air condition (exposing to oxygen in the air) to induce oxidation of Si on the surface of each Si particle, forming a shell layer of SiO₂ encapsulating an underlying Si core. The furnace was then pumped to a vacuum pressure of 20 Pa and heated to 1,050° C., maintaining at this temperature for 2 hours, enabling reactions between a SiO₂ shell and a Si core, along with sulfur and tin-nickel alloy, to obtain a gaseous mixture. This gaseous mixture (Ni/Sn/S-containing silicon oxide) was then directed to infiltrate into pores of graphene ball compacts (e.g., 14a, 14b, 14c, and 14b in FIG. 4).

Similar electrochemical tests as those described in Example 1 were performed and the data are given in Table 1.

### Example 11: Fabrication of Graphene Ball-Hosted SiOₓ Anode Material from Si, Zinc Oxide, and Black Phosphorus Particles

The process was similar to that described in Example 10, but the carbon host was graphene balls produced in Example 6. In one example, 5 kg silicon powder, 300 g zinc oxide and 50 g black phosphorus were mixed evenly and placed in a high temperature vacuum furnace. The apparatus was then heated to 600° C. and maintained at this temperature for 2 hours under a room air condition (exposing to oxygen in the air) to induce oxidation of Si on the surface of each Si particle, forming a shell layer of SiO₂ encapsulating an underlying Si core. The furnace was then pumped to a vacuum pressure of 120 Pa and heated to 1,050° C., maintaining at this temperature for 2.5 hours, enabling reactions between a SiO₂ shell and a Si core, along with zinc oxide, and black phosphorus, to obtain a gaseous mixture. This gaseous Zn/P-containing silicon oxide mixture was then introduced into pores of graphene balls. Similar electrochemical tests as those described in Example 1 were performed and the data are given in Table 1.

### Example 12: Fabrication of Porous Graphite Particle-Hosted SiOₓ Anode Material from Si and Alumina Particles

The process was similar to that described in Example 7, but the porous carbon host was the graphitic foam produced in Example 1. In one example, 5.0 kg Si and 260 g alumina were mixed evenly and placed in a high temperature vacuum furnace. The apparatus was then heated to 600° C. and maintained at this temperature for 6 hours under a room air condition (exposing to oxygen in the air) to induce oxidation of Si on the surface of each Si particle, forming a shell layer of SiO₂ encapsulating an underlying Si core. The furnace was then pumped to a vacuum pressure of 80 Pa and heated to 1100° C., maintaining at this temperature for 3 hours, enabling reactions between a SiO₂ shell and a Si core, along with magnesium oxide, to produce Al-containing SiOₓ. The temperature was also sufficient to sublime the reaction product (Al-containing SiOₓ) into a vapor state. The Al-containing SiOₓ vapor was flowed into the upper portion (second chamber) of the apparatus, where the vapor infiltrates into pores of the graphitic foam structure. Similar electrochemical tests as those described in Example 1 were performed and the data are given in Table 1.

### Example 13: Fabrication of SiOₓ Anode Material from Si and Selenium Dioxide Particles

The process was similar to that described in Example 12. In one example, 3 kg silicon powder and 90 g selenium dioxide were mixed evenly and placed in a high temperature vacuum furnace. The apparatus was then heated to 750° C. and maintained at this temperature for 2 hours under a room air condition to induce oxidation of Si on the surface of each Si particle, forming a shell layer of SiO₂ encapsulating an underlying Si core. The furnace was then pumped to a vacuum pressure of 80 Pa and heated to 1,050° C., maintaining at this temperature for 2 hours, enabling reactions between a SiO₂ shell and a Si core, along with selenium dioxide, to obtain a gaseous mixture. This gaseous mixture (Se-containing silicon oxide vapor) was introduced into pores of graphitic foams. Similar electrochemical tests as those described in Example 1 were performed and the data are given in Table 1.

### Comparative Example 1: Fabrication of SiOₓ Anode Material from Si Particles Alone

In an experiment, a sample of 5 kg silicon powder (no doping) having particle sizes of 0.6-2.3 μm was placed in a high-temperature furnace, FIG. 4. The apparatus was then heated to 800° C. and maintained at this temperature for 6 hours under a room air condition (exposing to oxygen in the air) to induce oxidation of Si on the surface of each Si particle, forming a shell layer of SiO₂ encapsulating an underlying doped Si core. The furnace was then pumped to a vacuum pressure of 10 Pa and heated to 1350° C., maintaining at this temperature for 3 hours, enabling reactions between a SiO₂ shell and a Si core to produce SiOₓ. The temperature was also sufficient to sublime the reaction product (SiOₓ) into a vapor state. The SiOₓ vapor was flowed into the upper portion (second chamber) of the apparatus where the vapor was cooled and deposited onto a surface of a solid collector. The SiOₓ solid deposit was removed from the collector surfaces and pulverized into smaller particles. A carbon precursor gas (mixture of argon and acetylene at a volume ratio of 5/2) was introduced into the chamber containing SiOₓ vapor to produce carbon-coated SiOₓ solid particles.

### Comparative Example 2: Fabrication of SiOₓ Anode Material from a Mixture of Si and SiO₂ Particles

In an experiment, 2.5 kg silicon powder (no doping) and 2.5 kg silica powder were mechanically mixed to obtain a solid mixture, which was placed in a high temperature furnace. The furnace was pumped to a vacuum pressure of 10 Pa and heated to 1350° C., maintaining at this temperature for 3 hours, enabling reactions between Si and SiO₂ to produce SiOₓ. The temperature was sufficient to sublime the reaction product (SiOₓ) into a vapor state. The SiOₓ vapor was flowed into the upper portion (second chamber) of the apparatus where the vapor was cooled and deposited onto a surface of a solid collector. The SiOₓ solid deposit was removed from the collector surfaces and pulverized into smaller particles. A carbon precursor gas (mixture of argon and acetylene at a volume ratio of 5/2) was introduced into the chamber containing SiOₓ vapor to produce carbon-coated SiOₓ solid particles.

### Comparative Example 3: Preparation of SiOₓ from a Mixture of Si, SiO₂, and Magnesium Oxide Particles

In one example, 3.0 kg Si, 2.5 kg SiO₂, and 230 g magnesium oxide were mixed evenly and placed in a high temperature vacuum furnace. The apparatus was then pumped to a vacuum pressure of 50 Pa and heated to 1200° C., maintaining at this temperature for 4 hours, enabling reactions between Si and SiO₂ particles, along with magnesium oxide, to produce Mg-containing SiOₓ. The temperature was also sufficient to sublime the reaction product (Mg-containing SiOₓ) into a vapor state. The Mg-containing SiOₓ vapor was flowed into the upper portion (second chamber) of the apparatus. A mixture of natural gas and propane at a volume ratio of 1:2 was then introduced into the upper chamber, allowing for carbon encapsulation of and/or mixing with Mg-containing SiOₓ particles. Similar electrochemical tests as those described in Example 7 were performed and the data are given in Table 1.

TABLE 1
Electrochemical testing data.

| | | Reversible | Capacity | Anode | Anode |
|---|---|---|---|---|---|
| Example (E) | | capacity | retention (%) | expansion (%) | expansion (%) |
| or Comparative | 1^{st}-cycle | at 0.1 C | after 600 | after 300 | after 600 |
| Example (CE) | Efficiency | (mAh/g) | cycles at 10 C | cycles at 10 C | cycles at 10 C |
| E7 | 93.3 | 1441 | 96 | 10.1 | 12.6 |
| E8 | 92.4 | 1488 | 95 | 11.1 | 14.1 |
| E9 | 91.8 | 1472 | 95 | 12.1 | 13.3 |
| E10 | 92.3 | 1492 | 95 | 12.0 | 14.4 |
| E11 | 91.7 | 1511 | 94 | 12.1 | 13.6 |
| E12 | 91.6 | 1504 | 94 | 12.7 | 14.5 |
| E13 | 91.3 | 1508 | 93 | 12.3 | 14.4 |
| CE1 | 81 | 1824 | 82 | 18.2 | 27.6 |
| CE2 | 77 | 1706 | 76 | 19.9 | 34.2 |
| CE3 | 82 | 1455 | 83 | 16.6 | 23.3 |

We have conducted an extensive and in-depth study on a new method of producing silicon oxide (SiOₓ) anode materials for use in a lithium-ion cell. The following is a summary of some of the more significant observations or conclusions: A facile and cost-effective method of mass-producing silicon oxide and carbon-coated silicon oxide powder has been developed. The SiOₓ-based anode materials doped with an element M provide the best performance in terms of delivering a high first-cycle efficiency and maintaining a high capacity for a long cycle life as compared to the SiOₓ anode active materials prepared by using prior art processes and/or those containing no doping by an element M, wherein M is preferably selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, As, or a combination thereof. The porous carbon host can accommodate the volume expansion of SiOₓ to the extent that the electrode expansion is significantly reduced.

We claim:

1. A porous carbon/silicon oxide composite comprising:
(a) a porous carbon structure host having pores; and
(b) a silicon oxide SiOₓ coating or particle residing in at least one of said pores, where 0<x <2, and wherein a weight fraction of SiOₓ in the composite is from 0.1% to 99%.

2. The porous carbon/silicon oxide composite of claim 1, further including a metal or non-metal element M dispersed in said SiOₓ or coated on a surface of said SiOₓ particle or coating, wherein M is selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, As, or a combination thereof, and M is present as individual M atoms embedded in the SiOₓ particle or coating, as a domain or phase comprising multiple M atoms that are dispersed in the SiOₓ, or as a compound selected from an oxide, boride, carbide, nitride, silicide, halogenide, phosphide, or selenide of M, or a combination thereof, and wherein M occupies from 0% to 30% by weight of the SiOₓ particle or coating

3. The porous carbon/silicon oxide composite of claim 2, wherein M occupies from 0.01% to 20% by weight of the SiOₓ particle or coating, or the weight fraction of SiOₓ in the composite is from 1% to 90%.

4. The porous carbon/silicon oxide composite of claim 1, wherein the pores have a pore size from 5 nm to 5 μm and the porous carbon structure host has a porosity level from 0.5% to 99% prior to hosting said silicon oxide.

5. The porous carbon/silicon oxide composite of claim 1, wherein the pores are interconnected to facilitate entry and infiltration of silicon oxide vapor in the pores and the porous carbon structure host has a porosity level from 50% to 90%.

6. The porous carbon/silicon oxide composite of claim 1, wherein said composite is in a particulate form having a particle size from 50 nm to 50 μm.

7. The porous carbon/silicon oxide composite of claim 1, wherein the porous carbon structure host comprises a material selected from carbon foam, graphite foam, graphene foam, carbon aerogel, graphite aerogel, graphene aerogel, activated carbon, porous soft carbon, porous hard carbon, porous graphite particle, porous graphene particle or graphene ball, porous meso-carbon micro-bead (MCMB), porous coke particle, a porous structure of pyrolyzed polymer or polymeric carbon, or a combination thereof.

8. The porous carbon/silicon oxide composite of claim 1, wherein the composite comprises at least a discrete, oxygen-free Si domain or phase dispersed in a SiOₓ matrix wherein the Si domain has a dimension from 2 nm to 500 nm.

9. The porous carbon/silicon oxide composite of claim 1, wherein the composite is in a particle form and the composite particle is further encapsulated by or coated with a layer of carbon, graphene, an ion-conducting polymer having a lithium ion conductivity no less than 10⁻⁶ S/cm, an electron-conducting polymer having an electric conductivity no less than 10⁻⁶ S/cm, or a combination thereof.

10. The porous carbon/silicon oxide composite of claim 9, wherein said ion-conducting polymer is selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

11. The porous carbon/silicon oxide composite of claim 9, wherein said electron-conducting polymer comprises a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy)phenylene vinylene), poly(p-phenylene vinylene), poly(2,5-dialkoxy) paraphenylene vinylene, poly [(1.4-phenylene-1.2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenylencethynylene), poly(2-decyloxy-1.4-phenylene), poly(9,9-dioctylfluorene), polyquinoline, a derivative thereof, a copolymer thereof, a sulfonated version thereof, or a combination thereof.

12. An anode for a lithium battery, wherein said anode comprises the porous carbon/silicon oxide composite of claim 1 as an anode material, an optional binder, and an optional conductive additive.

13. A lithium battery, wherein said lithium battery comprises an anode of claim 12, a cathode, a separator between the anode and the cathode, and an electrolyte in ionic contact with the anode and the cathode.

14. A method of producing porous carbon/silicon oxide composite of claim 1, said method comprising:
A) Preparing a reactant mixture of silicon dioxide (SiO₂) and silicon (Si) particles and preparing a porous carbon structure host having pores;
B) heating the reactant mixture to a reaction temperature under a vacuum or protective inert atmosphere for a length of reaction time to form silicon oxide, SiOₓ, and subliming or vaporizing said silicon oxide to a vapor state; and
C) directing the silicon oxide vapor to infiltrate at least a pore of the porous carbon structure host, which is maintained at a deposition temperature lower than the reaction temperature, facilitating the silicon oxide vapor to deposit as a solid in the pore to form the porous carbon/silicon oxide composite.

15. The method of claim 14, wherein step (C) further comprises a procedure of mechanically breaking down the porous carbon/silicon oxide composite into multiple composite particles of porous carbon/silicon oxide.

16. The method of claim 15, further comprising a step of prelithiating the multiple composite particles of porous carbon/silicon oxide to form composite particles of porous carbon/prelithiated silicon oxide.

17. The method of claim 15, further comprising a step of encapsulating or coating the multiple composite particles of porous carbon/silicon oxide with a layer of carbon, graphene, an ion-conducting polymer having a lithium ion conductivity no less than 10⁻⁶ S/cm, an electron-conducting polymer having an electric conductivity no less than 10⁻⁶ S/cm, or a combination thereof.

18. The method of claim 16, further comprising a step of encapsulating or coating the multiple composite particles of porous carbon/prelithiated silicon oxide with a layer of carbon, graphene, an ion-conducting polymer having a lithium ion conductivity no less than 10⁻⁶ S/cm, an electron-conducting polymer having an electric conductivity no less than 10⁻⁶ S/cm, or a combination thereof.

19. The method of claim 14, wherein the reactant mixture of silicon dioxide (SiO₂) and silicon (Si) particles in step (A) is prepared by providing multiple Si particles and heating the multiple Si particles to an oxidation temperature for a period of oxidation time to form a plurality of core-shell particles, wherein a core-shell particle comprises a layer of silicon dioxide, SiO₂, which at least partially covers or encapsulate an underlying silicon core.

20. The method of claim 14, wherein the reactant mixture further comprises a metal or non-metal element M, an M-containing alloy, or an M-containing compound that is mixed with said silicon dioxide (SiO₂) and silicon (Si) particles, wherein M is selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Sc, S, As, or a combination thereof; and wherein the silicon oxide vapor in step (B) comprises M and the deposited silicon oxide contains M that is doped or dispersed therein.

21. The method of claim 14, wherein (i) the silicon particles in step (A) comprise a plurality of silicon alloy particles, M_{y}Si, wherein M is a metal or non-metal element present on a surface of a silicon particle or in the interior of a silicon particle or (ii) the reactant mixture further comprises multiple M-containing particles; wherein M is selected from Al, Fe, Zn, Sn, Cu, Mn, Ni, Ti, V, Cr, Co, Zr, Nb, Mo, Ag, Au, Cd, Li, Na, K, Bc, Mg, Ca, B, C, Ge, Ga, In, Sb, Bi, N, P, Pb, Se, S, As, or a combination thereof, and y is selected from 0.001 to 4.4.

22. The method of claim 21, wherein step (A) comprises heating said (i) silicon alloy particles or (ii) mixture of multiple Si particles and multiple M-containing particles to a first temperature for a first period of time to form (iii) a plurality of composite particles or (iv) a mixture of a plurality of composite particles and multiple M-containing particles, wherein a composite particle comprises a layer of silicon dioxide, SiO₂, at least partially covering or encapsulating an underlying silicon alloy or silicon core, and wherein said step (B) comprises heating (iii) the plurality of composite particles or (iv) the mixture to a second temperature under a vacuum or protective inert atmosphere for a second duration of time, sufficient for facilitating the silicon dioxide to react with the underlying silicon alloy or silicon core of a composite particle to form a substantially silicon oxide particle, SiOₓ, having M dispersed therein and vaporizing said silicon oxide to a vapor state.

23. The method of claim 14, wherein the method, during or after Step (B), further comprises a step of introducing a stream of a precursor gas containing an element M to mix and react with the silicon oxide vapor to form vapor of M-containing silicon oxide, wherein M is a metal or non-metal element selected from Al, Fe, Zn, Sn, Cu, Mn, Ni, Ti, V, Cr, Co, Zr, Nb, Mo, Ag, Au, Cd, Li, Na, K, Be, Mg, Ca, B, C, Ge, Ga, In, Sb, Bi, N, P, Pb, Se, S, As, or a combination thereof, and M is present on a surface of a silicon oxide particle or in the interior of a silicon oxide after step (C) and the atomic ratio of M-to-Si in the M-containing silicon oxide is selected from 0.001 to 4.4.

24. The method of claim 21, wherein y is selected from 0.01 to 1.0.

25. The method of claim 21, wherein said M is introduced to the interior or surface of a silicon alloy particle by using doping, ion implementation, physical vapor deposition, sputtering, atomic layer deposition, chemical vapor deposition, solution deposition, coating, spraying, painting, or a combination thereof.

26. The method of claim 14, wherein a molar ratio of silicon-to-SiO₂ in a composite particle is from 1/100 to 100/1.

27. The method of claim 14, wherein the reaction temperature is from 1,100° C. to 1,500° C.

28. The method of claim 19, wherein the oxidation temperature is from 500° C. to 1,000° C.

29. The method of claim 19, wherein oxidation of Si particles is conducted in a first chamber and reactions of Si and SiO₂ is conducted in a first chamber or a second chamber of a reaction apparatus.

30. The method of claim 19, wherein said mechanical breaking comprises a procedure selected from grinding, mechanical milling, air jet milling, or ball-milling.

31. The method of claim 14, wherein the porous carbon structure host comprises porous particles and said step (C) is conducted in a fluidized bed environment to produce porous carbon/silicon oxide composite particles.
